(19) United States
(12) Patent Application Publication
(10) Pub. No.: US 2008/0301119 A1
(43) Pub. Date: Dec. 4, 2008

(54) SYSTEM FOR SCALING AND EFFICIENT HANDLING OF LARGE DATA FOR LOADING, QUERY, AND ARCHIVAL

(75) Inventors: Sai Sundar Selvaganesan, Cupertino, CA (US); Neelesh G. Gadhia, Sunnyvale, CA (US); Ambikeshwar Raj Merchia, Cupertino, CA (US); Chandrakant R. Bhat, Fremont, CA (US); Mangalakumar Saminathan Vanmanthai, Sunnyvale, CA (US); Leonid Gelman, San Jose, CA (US)

Correspondence Address: BEYER LAW GROUP LLP/YAHOO, PO BOX 1687, CUPERTINO, CA, 95015-1687, US

(73) Assignee: YAHOO! INC., Sunnyvale, CA (US)

(21) Appl. No.: 11/757,948

(22) Filed: Jun. 4, 2007

(51) Int. Cl. G06F 17/30

(52) U.S. Cl. 707/5; 707/E17.001

(57) ABSTRACT

A data query system is provided, which comprises: a data storage; a load server communicatively linked with the data storage and configured to store a plurality of data in the data storage as read-only data, and publish the plurality of read-only data; and a query server separate from the load server and communicatively linked with the load server and the data storage and configured to subscribe to the publication of the plurality of read-only data from the load server, and query the published plurality of read-only data to which it has subscribed in response to a query request.

### BACKGROUND

As the amount of information grows with scientific and technological advancement, the need for very large databases to store the available information becomes prevalent. Databases capable of storing 1 terabytes, 100 terabytes, 300 terabytes, or even greater amount of data are becoming more and more common. As a result, there is the need to manage, scale, query, or backup such very large amount of data efficiently.

One possible solution is to increase the processing power of the server responsible for managing and processing the information data as the amount of data increases. FIG. 1 is a block diagram illustrating a typical example of a system that includes a large data storage. As illustrated in FIG. 1, a single server 100 is linked to a large data storage 110, such as one or more disks. As new data 130 become available, they are pushed onto the data storage 110 by the server 100. The single server 100 manages the database and serves as both On-Line Transaction Processing (OLTP) and data warehouse or data mart system. The amount of data stored on the data storage 110 may be very large. For example, the amount of data may be greater than 1 terabytes, 100 terabytes, or even greater. In order to serve such large amount of data, the server 100 may have 32, 64, or even 128 Central Processing Units (CPU). Since the amount of available data increases continuously, it may be necessary to continuously upgrade the server 100 to have more and more processing power, in order to meet the demands of managing and querying the ever-increasing amount of data. In addition, archiving 120 becomes a very significant and mandatory process, for safekeeping as well as in reducing the time to backup this amount of data.

Servers with large number of CPUs are very expensive, and sometimes prohibitively expensive. Disk requirements for such a large system are not cheap either, and more importantly, the input/output (I/O) bandwidth becomes a priceless commodity. Thus, as the amount of available data increases, they become costlier to manage, and backup in terms of both money and time. Accordingly, moving to an economical as well as scalable solution with highly well-designed archiving policy is needed.

### SUMMARY

A system for querying a plurality of data is provided. A load server stores, processes, and publishes the plurality of data. A data storage communicatively linked with the load server stores the plurality of data. A query server, which is a separate component from the load server, communicatively linked with the load server and the data storage queries the plurality of data after they are published by the load server, wherein the query server subscribes to the publication of the plurality of data from the load server.

In another example, a method for querying a plurality of data is provided. The plurality of data are stored on a data storage, processed, and published by a load server. The plurality of data are queried by a query server after they are published by the load server, wherein the query server subscribes to the publication of the plurality of data from the load server.

These and other features will be described in more detail below in the detailed description and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram illustrating a typical example of a system that includes a large data storage.

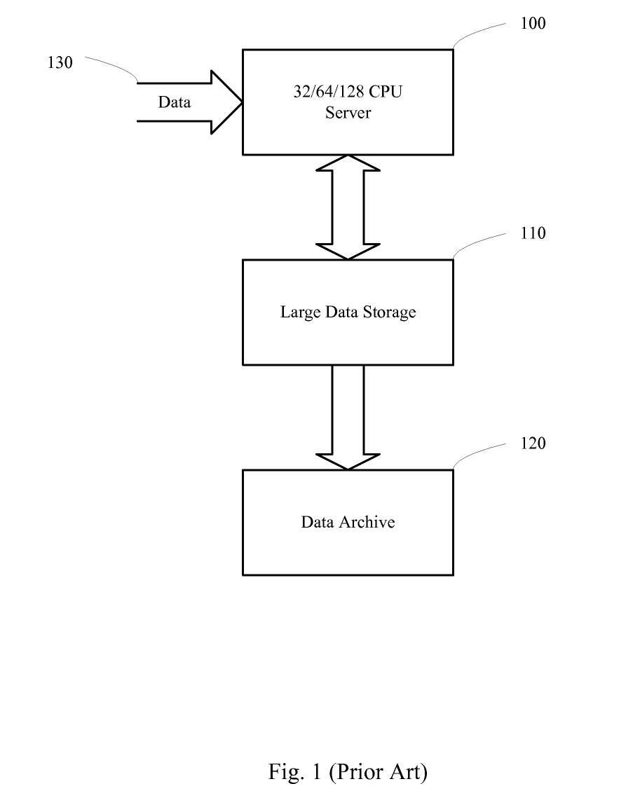

FIG. 2 is a block diagram illustrating an example of a system that separates the load server(s) from the query server(s).

FIG. 3 is a flowchart of a method for loading, processing, and publishing the data by the load server(s).

FIG. 4 is a flowchart of a method for querying the published data by the query server(s).

### DETAILED DESCRIPTION

As described above, it is more desirable to have an economical as well as scalable method when managing, processing, and archiving very large amount of data. In accordance with one aspect, the operations that are traditionally handled by a single server are allocated to multiple servers, with each server focusing on handling one type of operation. More specifically, one or more load servers are configured to process and load the data. These load servers are communicatively linked with one or more data storage units. As new data become available, the load servers process and store the data onto the data storage. When the data are ready for access, the load servers make the data read only and publish the data so that these data may be queried. On the other hand, one or more query servers are configured to handle the data query requests and query the data after they are published. These query servers are communicatively linked with the one or more data storage units, and subscribe to the load servers in order to receive publication notices from the load servers. The query servers are able to query published data.

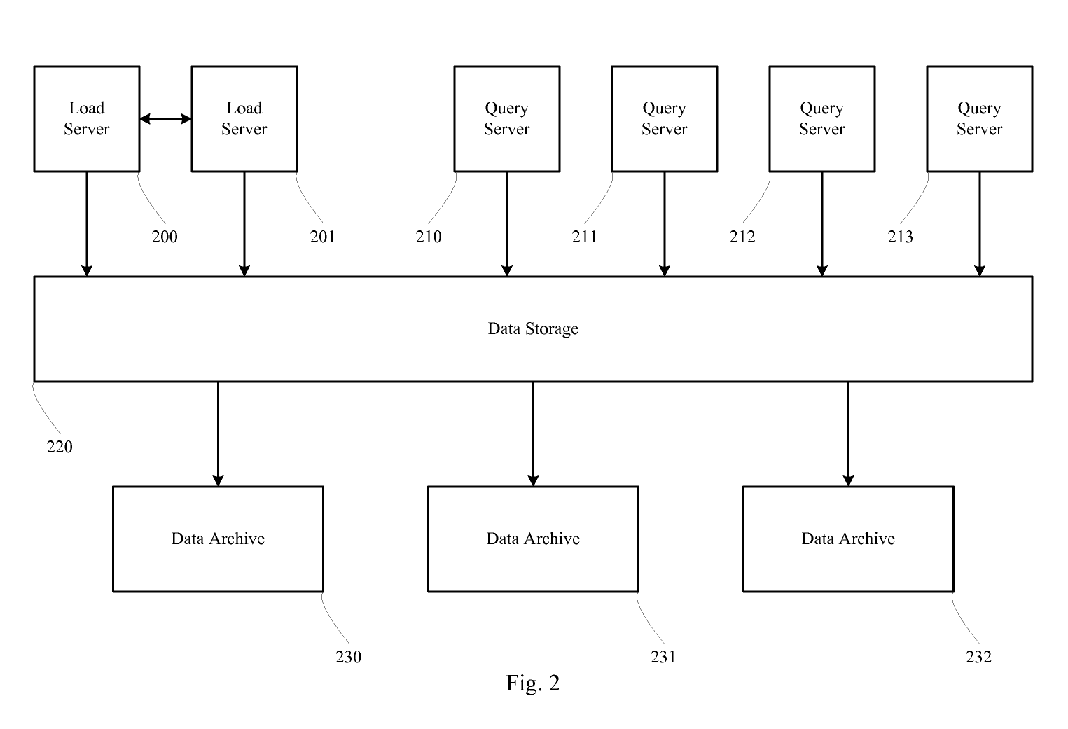

FIG. 2 is a block diagram illustrating an example of a system that separates the load server(s) from the query server(s). Referring to FIG. 2, there are one or more load servers 200, 201 that are communicatively linked with a large data storage 220. The number of load servers 200, 201 in the system may depend on the amount of data to be managed. Thus, for relatively small amount of data, one load server 200 may suffice, while for large amount of data, more load servers 200, 201 may be used. FIG. 2 shows two load servers 200, 201 merely as a way of illustrating the concept.

The load servers 200, 201 may be, for example, any type of database server. For example, each load server 200, 201 may be an Oracle Real Application Clusters (RAC) enabled database server. The load servers 200, 201 may have any number of CPUs. When choosing the amount of processing power for the load servers 200, 201, one may balance various factors, such as the amount of data to be managed, the monetary cost of the machines, and the type of analysis to be carried out on the data. For example, each load server 200, 201 may have 4 CPUs.

The load servers 200, 201 are configured to load the data onto the data storage 220. As new data becomes available, the load servers 200, 201 push the data onto the data storage 220 to be stored. In addition, the load servers 200, 201 may process the data in certain ways so that they may be efficiently retrieved in the future. For example, the data may be broken into segments, divided into categories based on the type of information they represent, reformatted so that they may be more suitably stored in a particular type of database, validated, partitioned based on a particular business strategy, organized, indexed etc. In other words, the load servers 200, 201 process the data according to the specific configurations of the system, so that in the future, the data may be queried, archived, or retrieved easily.

After the load servers 200, 201 complete loading a batch of data, the load servers 200, 201 then prepare that batch of data for publication. Data publication is the process that makes the data read only and available for query by the intended audience. The intended audience includes users who are authorized to access the data. The amount of time used for loading a batch of data may depend on how quickly new data becomes available. For example, if a large amount of new data becomes available during a short period of time, the new data may be published more often, perhaps on a daily basis, and vice versa.

To prepare for publication, the load servers 200, 201 make the batch of data read only. This may be achieved by marking the data unit in the database as stored in data storage 220, where the batch of data is stored, read only.

Next, the load servers 200, 201 construct metadata for each batch of data to be published. The metadata have information about the data themselves and may be used to describe the data to the query servers. For example, the metadata may include indexing information about the data. The metadata may be constructed according to how the data are stored in the database. Certain types of database servers, such as Oracle database server, provide utilities for constructing, incorporating, and/or integrating metadata into their framework. Such utilities may be utilized by the load servers 200, 201 in the construction of the metadata.

Generally, the metadata are much smaller in size in comparison to the corresponding data themselves, and thus, it is much faster and more efficient to transfer the metadata. In one example, the size ratio between the data and their corresponding metadata may be as much as 10⁶-to-1. Usually, the metadata are stored onto the data storage 220 along with their corresponding data. In one embodiment, the corresponding data and metadata are stored at the same physical location, but in different and separate logical entities (e.g. separate databases). This allows for easy separation of data and metadata when needed.

Thereafter, the load servers 200, 201 notify those query servers that have subscribed to the publication from the load servers 200, 201 that the data have been published. It may be either a pull or push technology to get the published data to the query servers. That is, load servers 200, 201 may send the metadata to the query servers along with publication notice, or the query servers may poll the load servers 200, 201 periodically and get the metadata along with the publication notice.

There are one or more query servers 210, 211, 212, 213 that are communicatively linked with the data storage 220 and the load servers 200, 201 directly or indirectly. The number of query servers 210, 211, 212, 213 used in the system may depend on the number of data query requests the system will serve. Thus, for relatively small number of query requests, one or two query servers 210, 211 may be used, while for large number of query requests, more query servers 210, 211, 212, 213 may be used. FIG. 2 shows four query servers 210, 211, 212, 213 merely as a way of illustrating the concept. In addition, the query servers 210, 211, 212, 213 may be of any type, and there may be different types of query servers within the same system. For example, one query server 210 may be hourly data reporting server, while another query server 212 may be a daily aggregate reporting server.

The query servers 210, 211, 212, 213 may have any number of CPUs. When choosing the amount of processing power for the query servers 210, 211, 212, 213, one may balance various factors, such as the number of query requests each server must handle and the monetary cost of the machines. For example, each query servers 210, 211, 212, 213 may have 4 CPUs.

Each query server 210, 211, 212, 213 is configured to register with the load servers 200, 201 in order to subscribe to the different data publication notices from the load servers 200, 201. What this means is that, although the load server 200, 201 form the only load servers in the complete architecture, the query servers have the capability to subscribe to the required loads and not all loads for a push model. Once the load servers 200, 201 send a publication notice to all the subscribing query servers 210, 211, 212, 213, each query server 210, 211, 212, 213 may either obtain the metadata for the published data directly from the load servers 200, 201, if the metadata are sent with the publication notice, or from the data storage 220. Thereafter, each query server 210, 211, 212, 213 may serve query requests to published data.

The system in FIG. 2 separates the data query operations from the data loading and processing operations. The load servers 200, 201 are responsible for loading, processing, and publishing the data, while the query servers 210, 211, 212, 213 are responsible for serving query requests to the read-only, published data.

Because the load servers 200, 201 only publish data at specific time intervals, it is possible that query requests may be made to some data before they are published. In this case, the query servers 210, 211, 212, 213 are unable to serve such requests, since unpublished data are not available to the query servers 210, 211, 212, 213. Instead, the load servers 200, 201 may serve query requests to unpublished data. However, to prevent these query requests from overwhelming the load servers 200, 201 and taking away their processing power from other important operations, query requests to unpublished data may be restricted to a limited number of authorized users, such as the system administrators. The intended audience generally waits until the data are published before making any query requests.

As shown in FIG. 2, the data storage 220 is shared among the load servers 200, 201 and the query servers 210, 211, 212, 213. Each server may access data stored on the data storage 220 directly.

Optionally, one or more data archives 230, 231, 232 are communicatively linked with the data storage 220. There are different types of data archive, such as magnetic tapes, memory storage, etc. Periodically, such as once a week or once a month depending on the amount of data available, the data stored on the data storage 220 along with the metadata may be backed up onto a data archive 230, 231, 232 for safekeeping. Thereafter, the archived data may be removed from the data storage 220 in order to make room for new data.

Because the data have been processed when they are initially loaded onto the data storage 220, archiving the data may take advantage of the fact that the data have already been categorized, partitioned, or formatted. Thus, data may be archived according to their categories or by segments. This can allow for efficient data retrieval in the future, that only a small segment of data need to be retrieved depending on the types of information required.

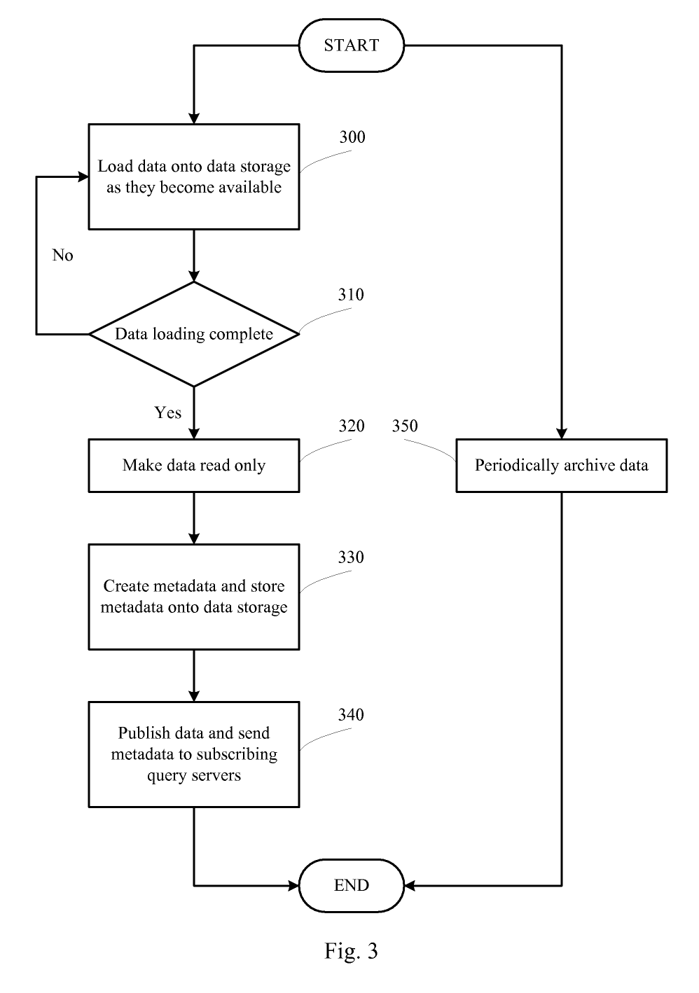

Having described a system architecture, we now describe particular methods of operating the system. FIG. 3 is a flowchart of a method for loading, processing, and publishing the data by the load server(s). This flowchart focuses on the operations of the load servers shown in FIG. 2.

At 300, as new data become available, they are loaded onto the data storage. Loading the data include pushing and storing the data onto the data storage and processing the data, such as by partitioning, categorizing, formatting, indexing, validating, etc.

At 310, the load servers check whether the loading of data is complete. This usually means checking whether the time interval for loading data has come to an end. For example, the load servers may stop loading data at the end of each day. If the end of the loading period has not been reached, the load servers continue loading new data as they become available.

On the other hand, if the end of the loading period has been reached, then at 320, the data are made read only. At 330, the load servers create metadata for the data just loaded and store the metadata onto the data storage along with the corresponding data or onto a separate data storage. Thereafter, at 340, the load servers publish the data by sending publication notice to the subscribing query servers along with the metadata.

On a separate path, at 350, the data stored on the data storage are periodically archived for safekeeping. Optionally, thereafter, the data no longer needed may be removed from data storage.

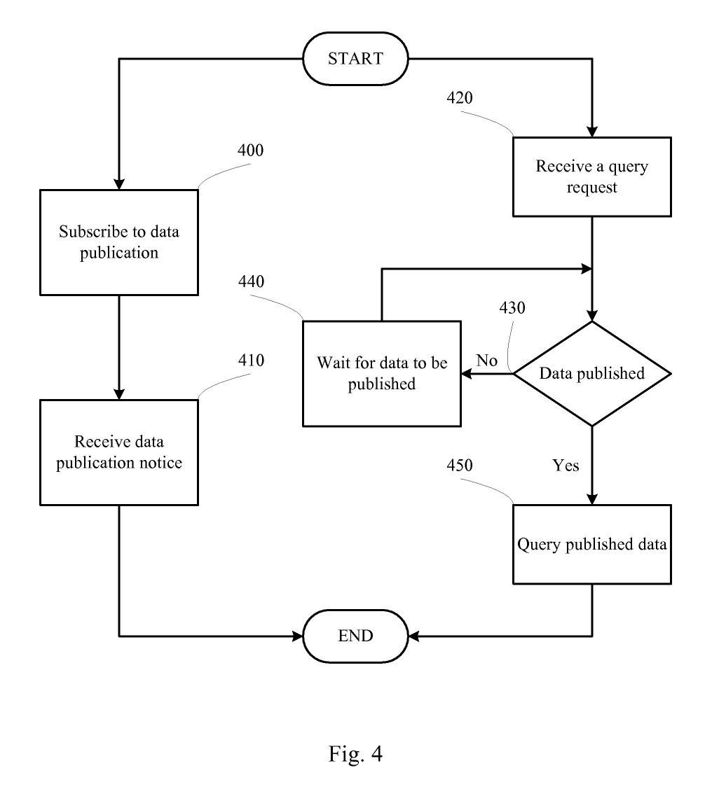

FIG. 4 is a flowchart of a method for subscribing and querying the published data by the query server(s). This flowchart focuses on the operations of the query servers shown in FIG. 2.

At 400, each query server needs to register with the load servers in order to subscribe to data publication notices, because the load servers only send publication notices to subscribing query servers. Once a query server has registered or subscribed to the load server, then at 410, the query server receives the data publication notices along with the metadata.

On a separate path, at 420, the query server receives a query request for some data. In one embodiment, a software application running on the query server handles all the query requests. At 430, the query server, via the software application, checks whether the queried data have been published. If the data have not been published, then at 440, the application waits until the data are published. Once the data are published, the query server may fulfill the query request at 450. On the other hand, if the data have been published, at 450, the query server may serve the query request for the published data immediately.

The methods described above may be carried out, for example, in a programmed computing system.

The system and method described above have various advantages over the single-server system setup. Most importantly, it is less expensive to have many servers, each having a small number of CPUs, working together than a single server having a large number of CPUs. In addition, the system is very scalable. As the amount of data increases, it is only necessary to add a new load server or query server in order to provide more processing power. Scaling horizontally is a more reliable and convenient way to serve data with no downtime.

In addition, by making the data read only, the data can be copied between two different compute systems located in different regions using standard operating system (OS) utilities. This reduces the overall cost and complexity of doing the Business Continuity Planning (BCP) between multiple locations.

Read only conversion before publishing provides two important benefits—the ability to publish this data in different query servers and the ability to back up this data once and only once. The effective backup size of the database is reduced to only the daily published data size along with the basic database metadata.

Archiving the data may be done efficiently. Because archiving is done periodically, only newly published data need to be archived. And because data have been processed when they are loaded onto the data storage, future retrieval of the data may be done efficiently by retrieving only a segment of the data relevant to the information needed.

The system and method described above works with any amount of data. However, the benefits of the system are especially noticeable when working with large quantity of data, such as data greater than 1 terabytes. In fact, as the size of the data grows, the benefits of the system become more and more prominent.

While this invention has been described in terms of several preferred embodiments, there are alterations, permutations, and various substitute equivalents, which fall within the scope of this invention. It should also be noted that there are many alternative ways of implementing the methods and apparatuses of the present invention. It is therefore intended that the following appended claims be interpreted as including all such alterations, permutations, and various substitute equivalents as fall within the true spirit and scope of the present invention.

What is claimed is:

1. A data query system, comprising:
a data storage;
a load server communicatively linked with the data storage and configured to store a plurality of data in the data storage as read-only data, and publish the plurality of read-only data; and
a query server separate from the load server and communicatively linked with the load server and the data storage and configured to
subscribe to the publication of the plurality of read-only data from the load server, and
query the published plurality of read-only data to which it has subscribed in response to a query request.

2. The system, as recited in claim 1, wherein the load server is further configured to
organize and categorize the plurality of read-only data,
create a plurality of metadata corresponding to the plurality of read-only data, wherein the plurality of metadata index the plurality of read-only data,
store the plurality of metadata in the data storage.

3. The system, as recited in claim 2, wherein publishing the plurality of read-only data by the load server comprises
sending the plurality of metadata by the load server to the query server;
receiving the plurality of metadata sent from the load server by the query server,
wherein the query server uses the plurality of metadata in connection with querying the corresponding plurality of read-only data.

4. The system, as recited in claim 1, wherein the load server is further configured to
organize and categorize the plurality of read-only data,
create a plurality of metadata corresponding to the plurality of read-only data, wherein the plurality of metadata index the plurality of read-only data,
store the plurality of metadata in a second data storage.

5. The system, as recited in claim 1, wherein the load server is further configured to query the plurality of data before they are published by the load server in response to a query request.

6. The system, as recited in claim 5, wherein querying the plurality of data by the load server before they are published is restricted to in response to the query request from an authorized entity only.

7. The system, as recited in claim 1, wherein the load server is further configured to gather the plurality of data over a period of time.

8. The system, as recited in claim 1, further comprising:
a data archive communicatively linked with the data storage configured to periodically archive the plurality of read-only data.

9. The system, as recited in claim 8, wherein
the load server is further configured to organize and categorize the plurality of read-only data, and
the data archive is further configured to periodically archive the plurality of read-only data based on their categories.

10. The system, as recited in claim 1, wherein the plurality of data are greater than 100 terabytes.

11. A data query method, comprising:
storing a plurality of data in a data storage as read-only data by a load server;
publishing the plurality of read-only data by the load server;
subscribing to the publication of the plurality of read-only data from the load server by a query server; and
querying the published plurality of read-only data to which the query server has subscribed in response to a query request by the query server,
wherein the load server is communicatively linked with the data storage, and the query server is separate from the load server and communicatively linked with the load server and the data storage.

12. The method, as recited in claim 11, further comprising:
organizing and categorizing the plurality of read-only data by the load server;
creating a plurality of metadata corresponding to the plurality of read-only data by the load server, wherein the plurality of metadata index the plurality of read-only data; and
storing the plurality of metadata in the data storage by the load server.

13. The method, as recited in claim 12, wherein publishing the plurality of read-only data by the load server comprises:
sending the plurality of metadata to the query server; and
receiving the plurality of metadata sent from the load server by the query server,
wherein the query server uses the plurality of metadata in connection with querying the corresponding plurality of read-only data.

14. The method, as recited in claim 11, further comprising:
organizing and categorizing the plurality of read-only data by the load server;
creating a plurality of metadata corresponding to the plurality of read-only data by the load server, wherein the plurality of metadata index the plurality of read-only data; and
storing the plurality of metadata in a second data storage by the load server.

15. The method, as recited in claim 11, further comprising:
querying the plurality of data by the load server before they are published in response to a query request; and
restricting the query of the plurality of data by the load server before they are published to in response to the query request from an authorized entity only.

16. The method, as recited in claim 11, further comprising:
periodically archiving the plurality of read-only data stored in the data storage to a data archive, wherein the data archive is communicatively linked with the data storage.

17. The method, as recited in claim 11, further comprising:
gathering the plurality of data for a period of time by the load server.

18. A computer program product for loading a plurality of data, the computer program product comprising a computer-readable medium having a plurality of computer program instructions stored therein, which are operable to cause at least one computer device to:
store a plurality of data in a data storage as read-only data by a load server;
publish the plurality of read-only data by the load server;
subscribe to the publication of the plurality of read-only data from the load server by a query server; and
query the published plurality of read-only data to which the query server has subscribed in response to a query request by the query server,
wherein the load server is communicatively linked with the data storage, and the query server is separate from the load server and communicatively linked with the load server and the data storage.

19. The computer program product, recited in claim 18, further comprising computer instructions to
organize and categorizing the plurality of read-only data by the load server;
create a plurality of metadata corresponding to the plurality of read-only data by the load server, wherein the plurality of metadata index the plurality of read-only data; and
store the plurality of metadata in the data storage by the load server.

20. The computer program product, recited in claim 19, wherein publishing the plurality of read-only data by the load server comprises computer instructions to
send the plurality of metadata to the query server; and
receive the plurality of metadata sent from the load server by the query server,
wherein the query server uses the plurality of metadata in connection with querying the corresponding plurality of read-only data.

21. The computer program product, recited in claim 18, further comprising computer instructions to
organize and categorizing the plurality of read-only data by the load server;
create a plurality of metadata corresponding to the plurality of read-only data by the load server, wherein the plurality of metadata index the plurality of read-only data; and
store the plurality of metadata in a second data storage by the load server.

22. The computer program product, recited in claim 18, further comprising computer instructions to
query the plurality of data by the load server before they are published in response to a query request.
restrict the query of the plurality of data by the load server before they are published to in response to the query request from an authorized entity only.

23. The computer program product, recited in claim 18, further comprising computer instructions to
periodically archive the plurality of read-only data stored in the data storage to a data archive, wherein the data archive is communicatively linked with the data storage.
